(19) United States
(12) Patent Application Publication
(10) Pub. No.: US 2026/0036878 A1
(43) Pub. Date: Feb. 5, 2026

(54) LIGHT-TRANSMITTING STRUCTURE AND ELECTRONIC DEVICE

(71) Applicant: Lenovo (Beijing) Limited, Beijing (CN)

(72) Inventors: Pandeng QIN, Beijing (CN); Shenghong LIAO, Beijing (CN)

(21) Appl. No.: 19/282,542

(22) Filed: Jul. 28, 2025

(30) Foreign Application Priority Data
Jul. 31, 2024 (CN) 202411046638.9

(51) Int. Cl. G03B 9/14

(52) U.S. Cl. CPC G03B 9/14

(57) ABSTRACT

A light-transmitting structure includes a first blade group, a second blade group, and a drive assembly. At least two first blades form a first hole. At least two second blades form a second hole. The first blade group and the second blade group are stacked over each other. The first hole is different from the second hole. The drive assembly is at least configured to drive the first blade group to form the first hole and drive the second blade group to form the second hole. The first hole and the second hole are used to allow light to pass through.

### CROSS-REFERENCES TO RELATED APPLICATION

The present disclosure claims priority to Chinese Patent Application No. 202411046638.9 filed on Jul. 31, 2024, the entire content of which is incorporated herein by reference.

### FIELD OF TECHNOLOGY

The present disclosure relates to the electronic device technology field and, more specifically, to a light-transmitting structure and an electronic device.

### BACKGROUND

To obtain shooting effects of different depths of field, the current aperture structure is relatively complex and requires closed-loop control, which is expensive. How to provide a light-transmitting structure that meets the needs of the shooting effects of different depths of field at a low cost has become a technical problem that needs to be solved.

### SUMMARY

One aspect of this disclosure provides a light-transmitting structure, including a first blade group, a second blade group, and a drive assembly. At least two first blades form a first hole. At least two second blades form a second hole. The first blade group and the second blade group are stacked over each other. The first hole is different from the second hole. The drive assembly is at least configured to drive the first blade group to form the first hole and drive the second blade group to form the second hole. The first hole and the second hole are used to allow light to pass through.

Another aspect of this disclosure provides an electronic device including an image acquisition element, a first blade group, a second blade group, and a controller. The image acquisition element includes a photosensitive surface. The first blade group and the second blade group are stacked over each other. The controller is configured to control the first blade group and the second blade group to form a first hole and a second hole, respectively. The first hole is different from the second hole. External light passes through the first hole or the second hole to be mapped onto a photosensitive surface of the image acquisition element.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic diagram of a camera assembly of an electronic device according to some embodiments of the present disclosure.

FIG. 2 is a schematic diagram of an aperture in FIG. 1.

FIG. 3 is a schematic exploded view of the aperture in FIG. 2.

FIG. 4 is a schematic diagram of a first blade group in FIG. 3.

FIG. 5 is a schematic diagram of a plate in FIG. 3.

FIG. 6 is a schematic diagram of a second blade group in FIG. 3.

FIG. 7 is a schematic diagram of a rotation frame in FIG. 3.

FIG. 8 is a schematic diagram of a fixed base in FIG. 3.

FIG. 9 is a schematic front view of the aperture after an outer shell is removed in FIG. 2.

FIG. 10 is a schematic rear view of FIG. 9.

FIG. 11 is a schematic bottom view of FIG. 9.

FIG. 12 is a schematic diagram showing the structure in FIG. 11 after removing the blade group and the plate.

FIG. 13 is a schematic diagram showing the structure in FIG. 9 after removing the plate.

FIG. 14 is a schematic diagram showing the structure in FIG. 13 after removing the first blade group.

FIG. 15 is a schematic diagram of a first hole formed by the first blade group of the aperture in FIG. 9.

FIG. 16 is a schematic diagram showing the structure in FIG. 15 after removing the first blade group and the plate.

FIG. 17 is a schematic diagram of a second hole formed by the second blade group of the aperture in FIG. 9.

FIG. 18 is a schematic diagram showing the structure in FIG. 17 after removing the first blade group and the plate.

Reference numerals:

| | | | |
|---|---|---|---|
| 1 Outer shell | 2 Flexible circuit board | 3 First blade group | |
| 4 Plate | 5 Second blade group | 6 Elastic member | |
| 7 Magnet | 8 Coil | 9 Fixed base | 10 Rotating frame |
| 310 First blade | 311 First guide segment | 312 Second guide segment | |
| 313 First position limiting hole | | | |
| 401 Clearance hole | 402 Third position limiting hole | | |
| 510 Second blade | 511 Third guide segment | 512 Fourth guide segment | |
| 513 Second position limiting hole | | | |
| 901 First fixed post | 902 Second fixed post | 903 Gap | |
| 101 First guide post | 102 Second guide post | 103 First gap | |
| 104 Second gap | | | |

### DETAILED DESCRIPTION

The present disclosure provides a light-transmitting structure. The light-transmitting structure can satisfy the needs of shooting effects of different depths of field at a low cost.

The technical solution of embodiments of the present disclosure is described in detail below in conjunction with the accompanying drawings of embodiments of the present disclosure. Obviously, the described embodiments are only some embodiments of the present disclosure, rather than all embodiments. Based on embodiments of the present disclosure, all other embodiments obtained by those of ordinary skill in the art without creative efforts shall fall within the scope of the present disclosure.

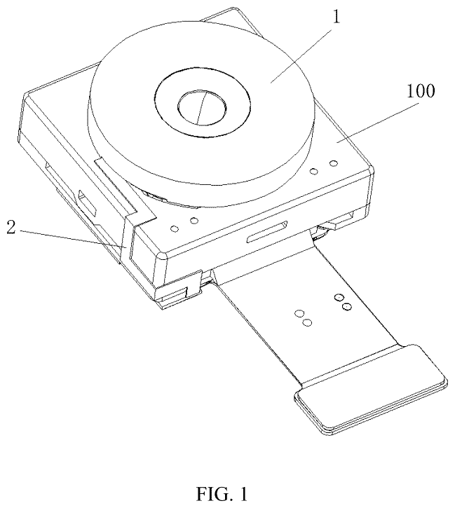

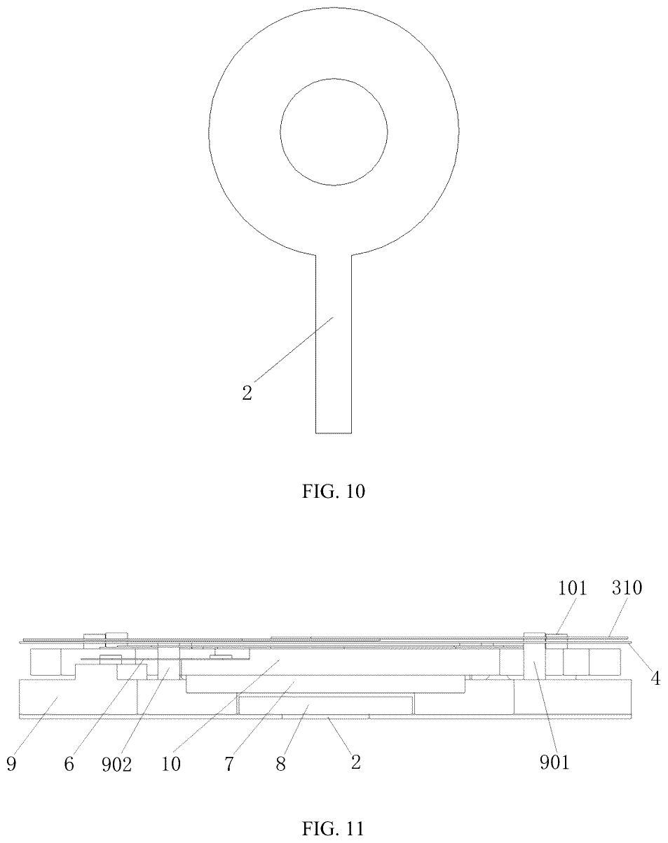

Referring to FIGS. 1 to 18, embodiments of the present disclosure provide a light-transmitting structure. The light-transmitting structure is exemplarily applied in a camera assembly shown in FIG. 1, and is embodied in the aperture structure described in detail below. The light-transmitting structure can be configured to control an amount of external light entering a lens assembly 100. The light-transmitting structure includes a first blade group 3, at least two first blades 310 forming a first hole, and a second blade group 5, at least two second blades 510 forming a second hole. The first blade group 3 and the second blade group 5 are stacked over each other. The first hole is different from the second hole. The light-transmitting structure further includes a drive assembly, at least configured to drive the first blade group 3 to form the first hole, and drive the second blade group 5 to form the second hole. The first hole and the second hole are used to let the light pass through. The drive assembly driving the first blade group 3 to form the first hole can include that at least two first blades 310 can move to target positions, respectively, under the action of the drive assembly to allow the first blades 310 to form a distribution shape along a complete circle to enclose to form the first hole configured to allow the light to pass through. Similarly, the drive assembly driving the second blade group 5 to form the second hole can include that at least two second blades 510 can move to target positions, respectively, under the action of the drive assembly to allow the second blades 510 to form a distribution shape along a complete circle to enclose to form the second hole. The first blade group 3 and the second blade group 5 are stacked over each other in a light transmitting direction (the direction of the center axis of the light-transmitting hole when the light-transmitting hole is a circular hole or other shapes symmetrical to their centers). The first hole and the second hole can have different light transmitting areas. Thus, through the driving of the drive assembly, the first blade group 3 can form the first hole, or the second blade group 5 can form the second hole, which can satisfy the needs for different light transmitting amounts.

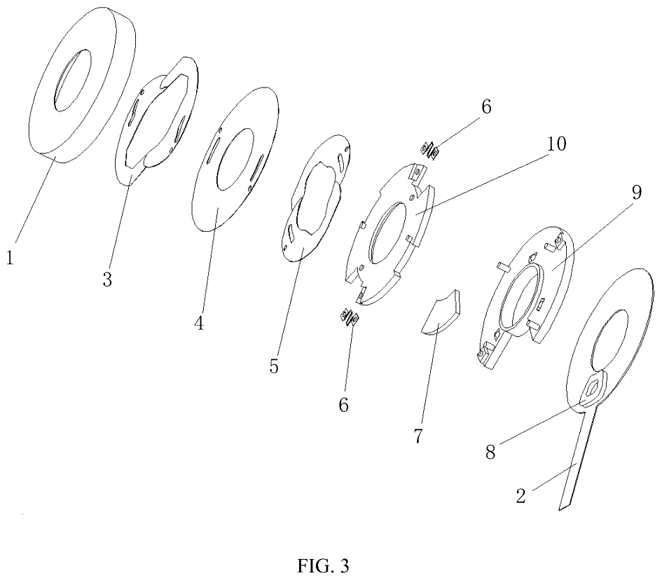

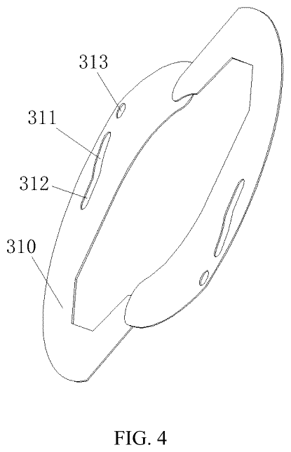

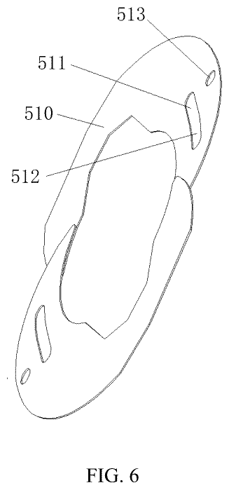

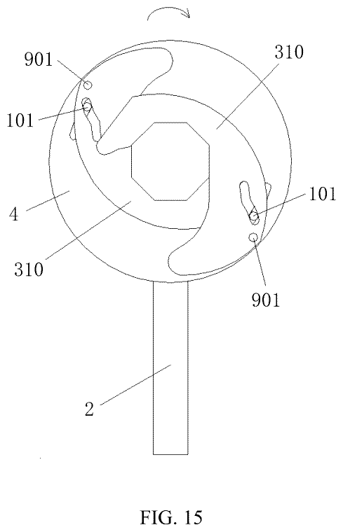

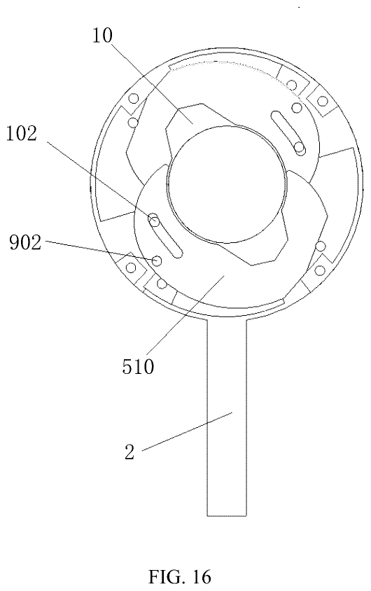

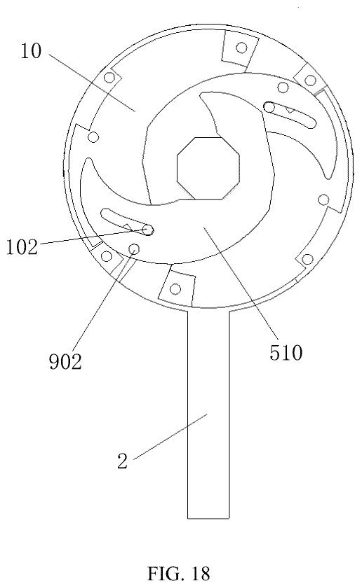

The first blade group 3 includes a plurality of blades, which can cooperate to form the first hole. In some embodiments, as shown in FIGS. 3 and 4, the first blade group 3 includes two first blades 310, which can form the first hole shown in FIG. 15. The first blade 310 can be set as hook-shaped. For example, the outer contour of the first blade 310 is C-shaped, and the two first blades 310 are arranged in reverse symmetry, and can enclose to form the first hole by moving to appropriate positions relative to each other. In some other embodiments, the number of the first blades 310 can be a different number, e.g., 3. The second blade group 5 includes a plurality of blades, which can cooperate to form the second hole. In some embodiments, as shown in FIGS. 3 and 6, the second blade group 5 includes two second blades 510, which form the second hole shown in FIG. 18. The second blade 510 can be set as hook-shaped. For example, the outer contour of the second blade 510 is C-shaped, and the two second blades 510 are arranged in reverse symmetry, and can enclose to form the second hole by moving to appropriate positions relative to each other. When the second blade group 5 includes two second blades 510, the structure can be simplified. In other embodiments, a number of the second blades 510 can be another value, e.g., 3.

In some embodiments, the drive assembly can drive the first blade group 3 to form the first hole. The first blade group 3 can be in a first state, and the second blade group 5 can be in a second state. The drive assembly can drive the second blade group 5 to form the second hole. The first blade group 3 can be in the second state, and the second blade group 5 can be in the first state. The blade group in the first state can be configured to cooperate to form the light-transmitting hole corresponding to the light-transmitting structure. The blade group in the second state may not be configured to cooperate to form the light-transmitting hole corresponding to the light-transmitting structure. The light-transmitting hole corresponding to the light-transmitting structure can be the final light-transmitting hole formed by the light-transmitting structure for use. The blade group in the first state can be configured to form the light-transmitting hole corresponding to the light-transmitting structure, while the blade group in the second state may not be configured to form the light-transmitting hole corresponding to the light-transmitting structure. The blade group in the second state may not affect the light-transmitting hole formed by the blade group in the first state. For example, after the first blade group 3 forms the first hole in the first state, in the state of the second blade group 5, the first hole cannot be blocked, and vice versa, after the second blade group 5 forms the second hole in the first state, in the state of the first blade group 3, the second hole cannot be blocked. That is, when one of the first blade group 3 and the second blade group 5 is in the first state forming the light-transmitting hole corresponding to the light-transmitting structure, the other one of the first blade group 3 and the second blade group 5 can be in the second state in which the light-transmitting hole corresponding to the light-transmitting structure may not be formed. Thus, the blades of the blade group in the second state can be presented in any distribution situation before forming the light-transmitting hole. For example, the blades of the blade group in the first state can be presented in a distribution situation where the blades are gathered to a certain extent, and the blades of the blade group in the second state can be presented in an initial distribution situation where the blades are not gathered, i.e., spread outward to the maximum extent, or in a distribution situation where the blades are gathered to half the extent, i.e., are gathered with the degree of gathering not reaching the degree required to form the light-transmitting hole.

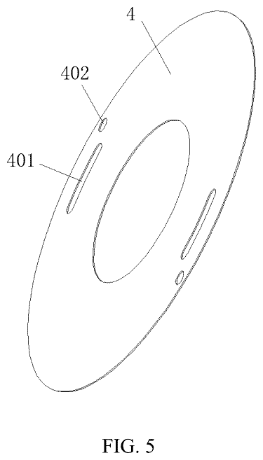

In some embodiments, the light-transmitting structure can further include a reference hole. If the first blade group 3 is in the first state to form the first hole, the area of the reference hole blocked by the first blade group 3 can be a first area. If the second blade group 5 is in the first state to form the second hole, the area of the reference hole blocked by the second blade group 5 can be a second area. The first area and the second area are different. That is, no matter whether the first blade group 3 is in the first state or the second blade group 5 is in the first state, the blade configured to form the light-transmitting hole corresponding light-transmitting structure can block a part of the reference hole. However, the areas of the reference hole blocked by the first blade group 3 and the second blade group 5 when forming the light-transmitting hole can be different. For example, as shown in FIG. 3 and FIG. 5, the reference hole is provided by a ring-shaped plate 4. The hole enclosed by the inner edge of the plate 4 is the reference hole. As shown in FIG. 15 and FIG. 18, the blocked area of the reference hole when the first blade group 3 forms the first hole for the light to pass is smaller than the blocked area of the reference hole when the second blade group 5 forms the second hole for the light to pass. Thus, the light transmitting area of the first hole is greater than the light transmitting area of the second hole. Then, when the first blade group 3 and the second blade group 5 form the light-transmitting hole, the first blade group 3 and the second blade group 5 can block a part of the reference hole. The light transmitting areas of the first hole and the second hole can be smaller than the light transmitting area of the reference hole. Thus, the light-transmitting structure can at least provide three different light-transmitting areas. That is, the light-transmitting structure can be configured to construct a three-level changeable aperture.

In some embodiments, the reference hole can be provided by the ring-shaped plate 4, and the hole enclosed by the inner edge of the plate 4 can be the reference aperture. The first blade group 3 and the second blade group 5 can be arranged on two sides of the plate 4, respectively. The first blade group 3, the plate 4, and the second blade group 5 can be sequentially stacked. The first blade group 3 and the second blade group 5 can also be arranged on a same side of the plate 4. The first blade group 3, the second blade group 5, and the plate 4 can be sequentially stacked, or the second blade group 5, the first blade group 3, and the plate 4 can be sequentially stacked.

In some embodiments, the drive assembly can include a first drive assembly and a second drive assembly that are independent of each other. The first drive assembly can be configured to drive the first blade group 3 to form the first hole, and the second drive assembly can be configured to drive the second blade group 5 to form the second hole. When the first blade group 3 is required to form the first hole, the second drive assembly may not operate, and the first drive assembly can drive the first blade group 3. When the second blade group 5 is required to form the second aperture, the first drive assembly may not operate, and the second drive assembly can drive the second blade group 5.

In some embodiments, the drive assembly can be a single drive assembly, which can drive the first blade group 3 and the second blade group 5.

In some embodiments, according to a motor type, the drive assembly can be a stepper motor, a voice coil motor, a shape memory alloy motor, a brushless DC motor, etc. According to a control mode of the motor, the drive assembly can be an open-loop control motor or a closed-loop control motor.

In some embodiments, in a process of the drive assembly driving the first blade group 3 to switch from the second state to the first state, the second blade group 5 can remain stationary. In a process of the drive assembly driving the second blade group 5 to switch from the second state to the first state, the first blade group 3 can remain stationary. That is, when the blades of one of the first blade group 3 and the second blade group 5 move and gather, the blades of the other one of the first blade group 3 and the second blade group 5 may not move. That is, each time when the light-transmitting hole corresponding to the light-transmitting structure needs to be formed, the drive assembly may only need to drive the blades of one of the first blade group 3 and the second blade group 5. Since the blades of the other one of the first blade group 3 and the second blade group 5 do not move, the load of the drive assembly can be relatively small. Thus, the requirement for the rated power of the drive assembly can be lowered, and the cost can be reduced. In some other embodiments, in the process of the drive assembly driving the first blade group 3 to switch from the second state to the first state, the drive assembly can simultaneously drive the second blade group 5 to move, but not to form the light-transmitting hole corresponding to the light-transmitting structure. In the process of the drive assembly driving the second blade group 5 to switch from the second state to the first state, the drive assembly can simultaneously drive the first blade group 3 to move, but not form the light-transmitting hole corresponding to the light-transmitting structure. That is, the drive assembly can drive two blade groups to move together, but the movement results of the two blade groups can be different. For example, when the drive assembly drives the first blade group 3 to switch from the second state to the first state, the movement result of the first blade group 3 can be forming the light-transmitting hole corresponding to the light-transmitting structure, and the movement result of the second blade group 5 may not affect the shape of the first hole formed by the first blade group 3. That is, when the first blade group 3 switches from the second state to the first state, although the second blade group 5 moves, the second blade group 5 can move under a plurality of different second states. Similarly, when the second blade group 5 switches from the second state to the first state, although the first blade group 3 moves, the first blade group 3 can move under a plurality of different second states.

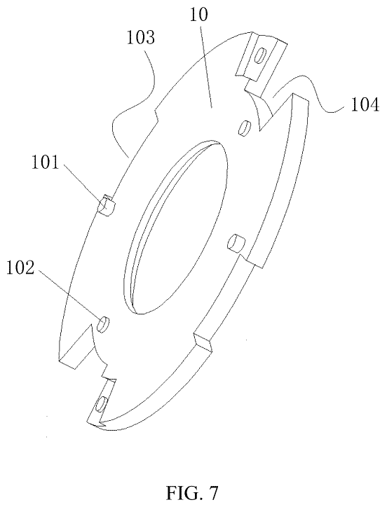

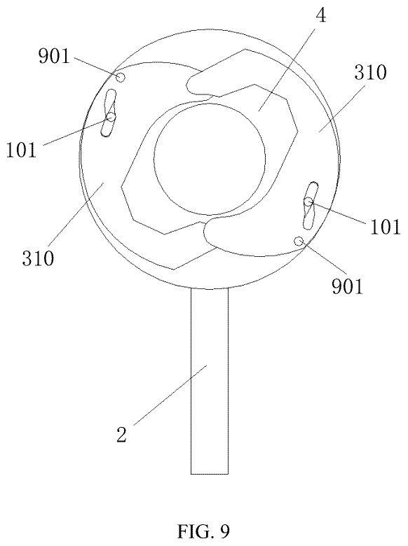

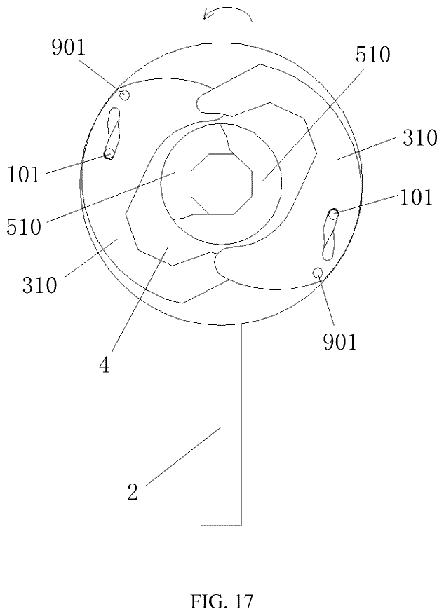

In some embodiments, the drive assembly can drive the first blade group 3 to switch from the second state to the first state along the first direction. The drive assembly can drive the second blade group 5 to switch from the second state to the first state along the second direction. The first direction can be different from the second direction. That is, the drive assembly can move along the first direction to drive the blades of the first blade group 3 to gather together, and the drive assembly can move along the second direction, different from the first direction, to drive the blades of the second blade group 5 to gather together. The first direction and the second direction can be two opposite directions. For example, as shown in FIGS. 3 and 7, the light-transmitting structure includes a transmission assembly. The transmission assembly includes a rotating frame 10. The drive assembly can drive the rotating frame 10 to drive the first blade group 3 and the second blade group 5. As shown in FIGS. 9 and 15, the drive assembly drives the rotating frame 10 to rotate clockwise (i.e., in the direction indicated by the arrow in FIG. 15), and the first blades 310 gather together to form the first hole. As shown in FIGS. 13 and 17, the drive assembly drives the rotating frame 10 to rotate counterclockwise (i.e., in the direction indicated by the arrow in FIG. 17), and the second blades 510 gather together to form the second hole. The first blade group 3 and the second blade group 5 can be driven by using movements in opposite directions, which is beneficial to save the moving space of the moving member to allow the overall layout of the light-transmitting structure to be more compact. Of course, when the light-transmitting structure has a sufficient volume, the relationship between the first direction and the second direction can have other forms. For example, the first direction and the second direction can be two directions with an angle of 30°, 60°, or 90°. In some embodiments, the drive assembly can be a single drive assembly, which can be configured to drive the first blade group 3 and the second blade group 5 in two different directions.

In some embodiments, the drive assembly can drive the transmission assembly to drive the first blade group 3. The transmission assembly can include a first guide post 101, and the first blade group 3 can include a first guide rail and a first fixed post 901. The first guide rail can include a first guide segment 311 and a second guide segment 312. The first guide post 101 can pass through the first guide rail and be arranged between the first guide segment 311 and the second guide segment 312. The drive assembly can drive the transmission assembly to move along the first direction, and the first blade group 3 can move with the first guide post 101 along the first guide segment 311. The first blade 310 can rotate around the first fixed post 901 to form the first hole. The drive assembly can drive the transmission assembly to move along the second direction, the first guide post 101 can move along the second guide segment 312, and the first blade group 3 can remain stationary. For example, as shown in FIGS. 3, 4, 7, and 8, the first guide post 101 of the transmission assembly is arranged at the rotating frame 10, and the first fixed post 901 of the first blade group 3 is arranged at the fixed base 9. The rotating frame 10 and the fixed base 9 are stacked, and the rotating frame 10 can rotate relative to the fixed base 9 when being driven by the drive assembly. The rotating frame 10 can include a first gap 103. The first fixed post 901 of the first blade group 3 can pass through the first gap 103 to be fixedly connected to the fixed base 9. The first gap 103 can allow the rotation of the rotating frame 10 to not be interfered with by the first fixed post 901. The first blade 310 can include a first position limiting hole 313 that rotatably cooperates with the first fixed post 901. The first guide rail of the first blade group 3 can be arranged at the first blade 310. The first guide segment 311 of the first guide rail can be closer to the first position limiting hole 313 than the second guide segment 312. As shown in FIGS. 9 and 15, the initial position of the first guide post 101 is between the first guide segment 311 and the second guide segment 312. When the drive assembly drives the rotating frame 10 to move clockwise as indicated by the arrow in FIG. 15, the first guide post 101 moves along the first guide segment 311. Since the extended trajectory of the first guide segment 311 satisfies the condition that the position on the first guide segment 311 that is farther from the second guide segment 312 has a larger distance from the rotation center of the rotating frame 10 when the first blade 310 is at the position shown in FIG. 9. Then, as the first guide post 101 moves along the first guide segment 311, the first blade 310 can rotate around the first fixed post 901. Then, the two first blades 310 can gather to form the first hole. When the drive assembly drives the rotating frame 10 to move in the counterclockwise direction indicated by the arrow shown in FIG. 17, the first guide post 101 moves along the second guide segment 312. Since the extended trajectory of the second guide segment 312 satisfies the condition that the positions at the second guide segment 312 have the same distance to the rotation center of the rotating frame 10 when the first blade 310 is at the position shown in FIG. 9, the first blades 310 may not move when the first guide post 101 moves along the second guide segment 312. That is, the first blade group 3 in FIG. 17 is in the same state as the first blade group 5 in FIG. 9. The first blades 310 do not gather.

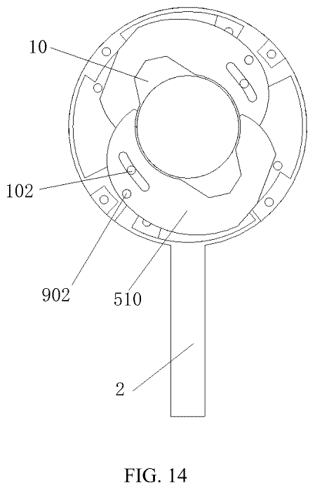

In some embodiments, the drive assembly can drive the transmission assembly to drive the second blade group 5. The transmission assembly can include a second guide post 102, and the second blade group 5 can include a second guide rail and a second fixed post 902. The second guide rail can include a third guide segment 511 and a fourth guide segment 512. The second guide post 102 can pass through the second guide rail and be arranged between the third guide segment 511 and the fourth guide segment 512. The drive assembly can drive the transmission assembly to move along the first direction. The second guide post 102 can move along the fourth guide segment 512, and the second blade group 5 can remain stationary. The drive assembly can drive the transmission assembly to move along the second direction. The second blade group 5 can move with the second guide post 102 at the third guide segment 511, and the second blades 510 can rotate around the second fixed post 902 to form the second hole. For example, as shown in FIGS. 3, 6, 7, and 8, the second guide post 102 of the transmission assembly is arranged at the rotating frame 10, and the second fixed post 902 of the second blade group 5 is arranged at the fixed base 9. The rotating frame 10 and the fixed base 9 are stacked, and the rotating frame 10 can rotate relative to the fixed base 9 when being driven by the drive assembly. The rotating frame 10 can include a second gap 104. The second fixed post 902 of the second blade group 5 can pass through the second gap 104 and be fixedly connected to the fixed base 9. The second gap 104 can allow the rotating frame 10 to rotate without being interfered with by the second fixed post 902. The second blade 510 can include a second position limiting hole 513 that rotatably cooperates with the second fixed post 902. The second guide rail of the second blade group 5 can be arranged at the second blade 510. The third guide segment 511 of the second guide rail can be closer to the second position limiting hole 513 than the fourth guide segment 512. As shown in FIGS. 14 and 16, the initial position of the second guide post 102 is between the third guide segment 511 and the fourth guide segment 512. When the drive assembly drives the rotating frame 10 to move clockwise as indicated by the arrow in FIG. 15, the second guide post 102 moves along the fourth guide segment 512. Since the extended trajectory of the fourth guide segment 512 satisfies the condition that the positions on the fourth guide segment 512 have the same distance to the rotation center of the rotating frame 10 when the second blades 510 are at the position shown in FIG. 14, the second blades 510 do not move when the second guide post 102 moves along the fourth guide segment 512. That is, the second blade group 5 in FIG. 16 and the second blade group 5 in FIG. 14 are in the same state, and the second blades 510 do not gather. When the drive assembly drives the rotating frame 10 to move along the counterclockwise direction indicated by the arrow in FIG. 17, the second guide post 102 moves along the third guide segment 511. Since the extended trajectory of the third guide segment 511 satisfies the condition that the position at the third guide segment 511 that is farther from the fourth guide segment 512 has a larger distance to the rotation center of the rotating frame 10 when the second blades 510 are at the position shown in FIG. 14, the second blades 510 rotate around the second fixed post 902, and the two second blades 510 gather to from the second hole shown in FIG. 18.

In some embodiments, if the first blade group 3 and the second blade group 5 are arranged on the same side of the transmission assembly, the first guide post 101, the first fixed post 901, the second guide post 102, and the second fixed post 902 can be arranged on the same side of the transmission assembly. Thus, the positions of the first guide post 101 and the first fixed post 901 at the transmission assembly must not affect the movement of the second blade group 5. The positions of the second guide post 102 and the second fixed post 902 on the transmission assembly must not affect the movement of the first blade group 3.

In some embodiments, as shown in FIG. 4, the second guide segment 312 is set as a long hole in an arc trajectory. In other embodiments, the second guide segment 312 can be set to other shapes. For example, based on the structure shown in FIG. 4, the side edge of the second guide segment 312 can be further expanded outwardly to change the shape of the second guide segment 312 from the long hole in the arc trajectory to a rectangle, a circle, or an oval with a larger area, as long as the first guide post 101 can move on the second guide segment 312, and the first blades 310 can remain stationary. In addition, in some embodiments, as shown in FIG. 4, the width of the first guide segment 311 matches the diameter of the first guide post 101. Then, when the first guide post 101 moves along the first guide segment 311 toward the second guide segment 312, the first guide post 101 can apply a force to an inner wall of the first guide segment 311 to allow the first blades 310 to rotate around the first fixed post 901. Thus, the first blades 310 can return to the initial position before forming the first hole. In other embodiments, the reset movement of the first blades 310 can be achieved by a torsion spring provided on the first fixed post 901. Then, the first guide segment 311 can be set to other shapes.

Similarly, in some embodiments, as shown in FIG. 6, the fourth guide segment 512 is set as a long hole in an arc trajectory. In other embodiments, the fourth guide segment 512 can be set to other shapes. For example, based on the structure shown in FIG. 6, the side edge of the fourth guide section 512 can be further expanded outwardly to change the shape of the fourth guide section 512 from the long hole in the arc trajectory to a rectangle, a circle, or an oval with a larger area, as long as the second guide post 102 can move a the fourth guide segment 512, and the second blades 510 can remain stationary. In some embodiments, as shown in FIG. 6, the width of the third guide segment 511 matches the diameter of the second guide post 102. Then, when the second guide post 102 moves along the third guide segment 511 toward the fourth guide segment 512, the second guide post 102 can apply a force to the inner wall of the third guide segment to allow the second blades 510 to rotate around the second fixed post 902 to allow the second blades 510 to return to the initial position before forming the second hole. In some other embodiments, the reset movement of the second blades 510 can be achieved by a torsion spring provided at the second fixed post 902. Then, the third guide segment 511 can have other shapes.

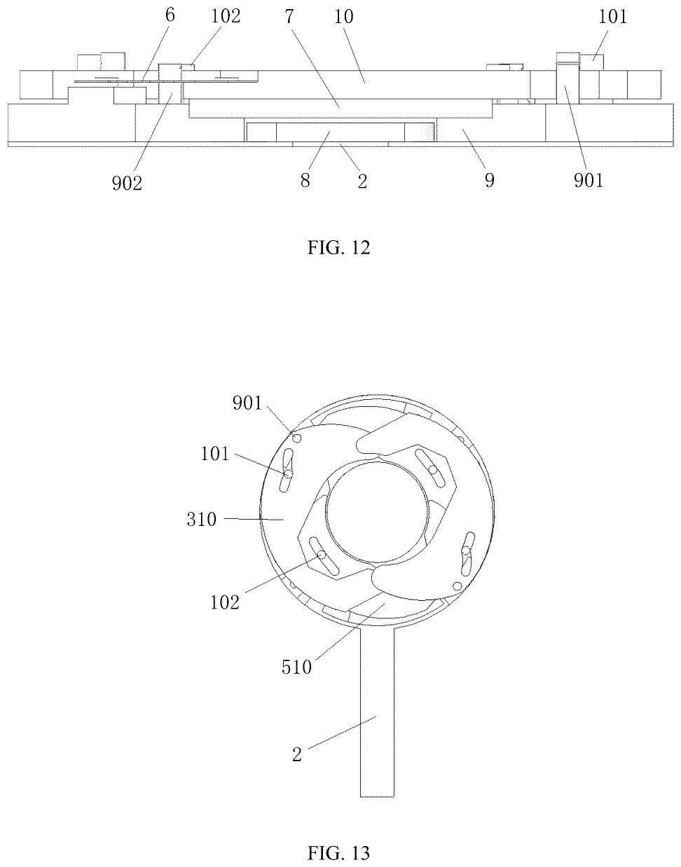

As shown in FIGS. 9, 11, and 13, in some embodiments, the light-transmitting structure includes the plate 4 providing the reference hole. The first blade group 3 and the second blade group 5 are arranged on both sides of the plate 4. For example, the first blade group 3 is stacked with the plate 4 and arranged on a side of the plate 4 away from the rotating frame 10. The second blade group 5 is stacked with the plate 4 and arranged on a side of the plate 4 close to the rotating frame 10. As shown in FIGS. 11 and 12, in some embodiments, the blade group and the plate 4 can be arranged on a side of the rotating frame 10 away from the fixed base 9. In this structure, as shown in FIGS. 5, 7, and 8, the plate 4 includes a third position limiting hole 402 for the first fixed post 901 to pass through and a clearance hole 401 capable of accommodating the movement of the first guide post 101. The extended trajectory of the clearance hole 401 can satisfy the condition that positions on the extended trajectory have the same distance to the rotation center of the rotating frame 10. The two first fixed posts 901 can pass through the third position limiting holes 402, respectively, to cause the plate 4 not to rotate relative to the fixed base 9.

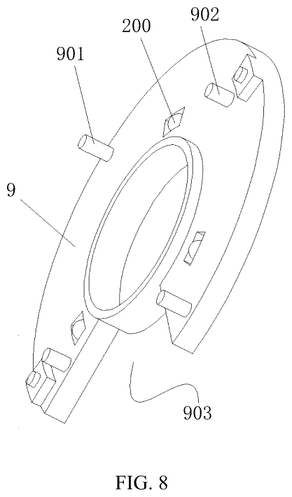

As shown in FIG. 8, in some embodiments, the light-transmitting structure includes balls 200 arranged between the rotating frame 10 and the fixed base 9, the balls 200 support the rotating frame 10 and the fixed base 9 along a direction satisfying a parallel condition with the rotation axis of the rotating frame 10. The balls 200 can make the movement of the rotating frame 10 smoother, and help reduce the wear of the rotating frame 10 during the movement. Thus, a failure rate during the use of the light-transmitting structure can be lowered to extend the service life of the light-transmitting structure.

As shown in FIG. 3, in some embodiments, the drive assembly includes a coil 8 and a magnet 7. One of the coil 8 and the magnet 7 is fixed to the fixed base 9, and the other one of the coil 8 and the magnet 7 is fixed to the rotating frame 10. After the coil 8 is powered on, an interaction force is generated between the coil 8 and the magnet 7 to cause the rotating frame 10 and the fixed base 9 to move relatively. In some embodiments, the light-transmitting structure can include an elastic member 6 connecting the rotating frame 10 and the fixed base 9. The elastic member 6 can be configured to drive the rotating frame 10 to automatically reset after the coil 8 is powered off. The elastic member 6 can have various structures, e.g., an S-shaped spring or a helical spring. In some embodiments, as shown in FIG. 11, the coil 8 and the magnet 7 are sequentially arranged along a direction satisfying the parallel condition with the rotation axis of the rotating frame 10 (e.g., the axial direction of the aperture). In other embodiments, the coil 8 and the magnet 7 can also be sequentially arranged along a direction satisfying a vertical condition with the rotation axis of the rotating frame 10 (e.g., the radial direction of the aperture).

As shown in FIGS. 3 and 8, in some embodiments, the body of the fixed base 9 is set as a ring body with a gap 903 at the edge of the fixed base 9. The coil 8 is arranged in an accommodation space formed by the gap 903. Then, the overall size of the light-transmitting structure in the stacking direction of the rotating frame 10 and the fixed base 9 can be facilitated to be reduced. As shown in FIG. 3, in some embodiments, the coil 8 is connected to the power module through a flexible circuit board 2. A first member of the flexible circuit board 2 is fixedly connected to the fixed base 9, and the coil 8 is fixed to the fixed base 9 and is electrically connected to the flexible circuit board 2. For example, the first member of the flexible circuit board 2 can be in a ring shape and can be fixedly connected to a side of the body of the fixed base 9 away from the rotating frame 10 through adhesive bonding.

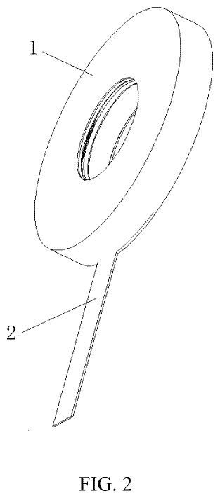

As shown in FIGS. 1 to 3, in some embodiments, the light-transmitting structure includes an outer shell 1. The outer shell 1 and the first member of the flexible circuit board 2 form an accommodation chamber. Other members of the light-transmitting structure are accommodated in the accommodation chamber. When the light-transmitting structure is applied to a camera assembly with an optical image stabilization (OIS) function as the aperture, the aperture and the lens assembly 100 can move relatively along the radial direction of the aperture. Meanwhile, to adapt to the extension and retraction of the lens along the axial direction of the aperture during zooming, the aperture and the lens assembly 100 can move relatively along the axial direction of the aperture. To cause the flexible circuit board 2 to satisfy the requirements of the aperture and the lens assembly 100 moving relatively along the directions, the flexible circuit board 2 is set to the shape shown in FIG. 2. In this structure, the flexible circuit board 2 can have a plurality of bends. With these bends, the second member of the flexible circuit board 2 can have a perspective bending shape. Thus, the flexible circuit board 2 can have an elastic deformation in various directions to satisfy the requirement that the aperture and the lens assembly can move relatively.

The present disclosure further provides an electronic device, including an image acquisition element having a photosensitive surface, a first blade group 3, a second blade group 5, and a controller. The first blade group 3 and the second blade group 5 can be stacked. The controller can be configured to control the first blade group 3 and the second blade group 5 to form a first hole and a second hole, respectively. The first hole can be different from the second hole. External light can pass through the first hole or the second hole to be mapped to the photosensitive surface of the image acquisition element. In the electronic device, the first hole and the second hole formed by the stacked first blade group 3 and second blade group 5, respectively, can be configured to allow the external light to pass through. For the technical effects of the electronic device, reference can be made to the description of the light-transmitting structure, which is not repeated here.

The electronic device can include a mobile phone, a tablet computer, a notebook computer, or a digital camera. In some embodiments, the electronic device can include a drive assembly, a controller. The controller can be connected to the drive assembly. The drive assembly can be at least configured to drive the first blade group 3 to form the first hole and drive the second blade group 5 to form the second hole. The controller can be configured to control the drive assembly to output a first electrical signal, and the first blade group 3 can form the first hole. The controller can control the drive assembly to output a second electrical signal, and the second blade group 5 can form the second hole. The first electrical signal and the second electrical signal can be opposite signals. For example, in some embodiments, the drive assembly can include a magnet 7 and a coil 8. When the coil 8 is powered on with a positive current, the first blade group 3 can be driven to move to form the first hole. When the coil 8 is powered on with a negative current, the second blade group 5 can be driven to move to form the second hole. The stacked first blade group 3 and second blade group 5 can be configured to form the first hole and the second hole. A simple open-loop control can be used to satisfy the requirements of the application function on the control system. That is, the requirements for closed-loop control can be reduced. Then, the drive assembly can be allowed to have a relatively simpler structure. Thus, with the light-transmitting structure of the present disclosure having a relatively simpler overall structure, the open-loop control can be used to realize the variable aperture to satisfy the requirements of shooting effects of different depths of field and reduce the cost. That is, with the light-transmitting structure of the present disclosure, the requirement of shooting effects of different depths of field can be satisfied at a low cost. In the present disclosure, the first blade group 3 and the second blade group 5 can be driven by opposite electrical signals. This drive method can be controlled by an open-loop, and can have a low cost. The drive method can also be controlled by another open-loop control method, which is not listed here. In addition, in the present disclosure, a motor with higher control accuracy can be applied to drive the light-transmitting structure in a closed-loop control method, which can have a higher cost than the open-loop control method.

As shown in FIG. 3, the drive assembly can drive through the magnet 7 and the coil 8. The magnet 7 is arranged at one position of the light-transmitting structure to realize a single-sided magnet design. Since the magnet 7 is arranged on only one side, and there is no magnet 7 in other positions, the interference of an external magnetic field can be beneficially lowered. That is, the ability to resist magnetic interference can be stronger.

In some embodiments, the electronic device can include a reference hole. The reference hole is different from the first hole and the second hole. The controller may not output electrical signals for controlling the first blade group 3 and the second blade group 5. The external light can pass through the reference hole and can be mapped onto the photosensitive surface of the image acquisition element. That is, when the first hole and the second hole are not formed, the reference hole can be configured to allow the light to pass through and control the amount of light. For example, in some embodiments, the drive assembly can include the magnet 7 and the coil 8. When the coil 8 is not powered on, the first blade group 3 and the second blade group 5 may not operate, and the first hole and the second hole may not be formed. Then, the external light can pass through the reference hole and can be mapped onto the photosensitive surface of the image acquisition element. The reference hole, the first hole, and the second hole can have different light transmitting areas. Thus, the electronic device can have a three-level variable aperture and can obtain shooting effects of different depths of field to satisfy the application requirements of the user for a plurality of shooting scenarios.

In this specification, the structures of various members are described in a progressive manner. The structure of each member focuses on the differences from existing structures. The overall and partial structures of the electronic device can be obtained by grouping the structures of the plurality of members above.

The above description of embodiments of the present disclosure can enable those skilled in the art to implement or use the present disclosure. Various modifications to embodiments of the present disclosure are apparent to those skilled in the art. The general principles defined here can be implemented in other embodiments without departing from the spirit or scope of the present disclosure. Therefore, the present disclosure is not limited to embodiments of the present disclosure but conforms to the widest scope consistent with the principles and novel features of the present disclosure.

What is claimed is:

1. A light-transmitting structure comprising:
a first blade group, at least two first blades forming a first hole;
a second blade group, at least two second blades forming a second hole, the first blade group and the second blade group being stacked on each other, and the first hole being different from the second hole; and
a drive assembly at least configured to drive the first blade group to form the first hole and drive the second blade group to form the second hole;
wherein the first hole and the second hole are used to allow light to pass through.

2. The light-transmitting structure according to claim 1, wherein:
the drive assembly drives the first blade group to form the first hole, the first blade group is in a first state, and the second blade group is in a second state;
the drive assembly drives the second blade group to form the second hole, the first blade group is in the second state, and the second blade group is in the first state; and
one of the first blade group and the second blade group in the first state is configured to cooperate to form a light-transmitting hole corresponding to the light-transmitting structure, and one of the first blade group and the second blade group in the second state is not configured to cooperate to form a light-transmitting hole corresponding to the light-transmitting structure.

3. The light-transmitting structure according to claim 2, wherein:
during a process of the drive assembly driving the first blade group to switch from the second state to the first state, the second blade group remains stationary; and
during a process of the drive assembly driving the second blade group to switch from the second state to the first state, the first blade group remains stationary.

4. The light-transmitting structure according to claim 2, further comprising a reference hole, wherein:
in response to the first blade group being in the first state to form the first hole, an area of the reference hole blocked by the first blade group is a first area;
in response to the second blade group being in the first state to form the second hole, an area of the reference aperture blocked by the second blade group is a second area; and
the first area and the second area are different.

5. The light-transmitting structure according to claim 2, wherein:
the drive assembly drives the first blade group along a first direction to switch from the second state to the first state;
the drive assembly drives the second blade group along a second direction to switch from the second state to the first state; and
the first direction is different from the second direction.

6. The light-transmitting structure according to claim 5, further comprising a transmission assembly, wherein:
the drive assembly drives the transmission assembly to drive the first blade group;
the transmission assembly includes a first guide post;
the first blade group includes a first guide rail and a first fixed post, the first guide rail including a first guide segment and a second guide segment;
the first guide post passes through the first guide rail and is arranged between the first guide segment and the second guide segment;
the drive assembly drives the transmission assembly to move along the first direction, the first blade group moves with the first guide post at the first guide segment, and the first blades rotate around the first fixed post to form the first hole; and
the drive assembly drives the transmission assembly to move along the second direction, the first guide post moves at the second guide segment, and the first blade group remains stationary.

7. The light-transmitting structure according to claim 6, wherein:
the transmission assembly includes a second guide post;
the second blade group includes a second guide rail and a second fixed post, and the second guide rail includes a third guide segment and a fourth guide segment;
the second guide post passes through the second guide rail and is arranged between the third guide segment and the fourth guide segment;
the drive assembly drives the transmission assembly to move along the first direction, the second guide post moves at the fourth guide segment, and the second blade group remains stationary; and
the drive assembly drives the transmission assembly to move along the second direction, the second blade group moves with the second guide post at the third guide segment, and the second blades rotate around the second fixed post to form the second hole.

8. An electronic device comprising:
an image acquisition element including a photosensitive surface;
a first blade group and a second blade group stacked over each other; and
a controller configured to control the first blade group and the second blade group to form a first hole and a second hole, respectively, the first hole being different from the second hole, and external light transmitting through the first hole or the second hole to be mapped onto a photosensitive surface of the image acquisition element.

9. The electronic device according to claim 8, further comprising:
a drive assembly connected to the controller, and at least configured to drive the first blade group to form the first hole and drive the second blade group to form the second hole;
wherein:
the controller controls the drive assembly to output a first electrical signal to cause the first blade group to form the first hole;
the controller controls the drive assembly to output a second electrical signal to cause the second blade group to form the second hole; and
the first electrical signal and the second electrical signal are opposite signals.

10. The electronic device according to claim 9, wherein:
the controller controls the drive assembly to drive the first blade group to form the first hole, the first blade group is in a first state, and the second blade group is in a second state;
the controller controls the drive assembly to drive the second blade group to form the second hole, the first blade group is in the second state, and the second blade group is in the first state; and
one of the first blade group and the second blade group in the first state is configured to cooperate to form a light-transmitting hole corresponding to the light-transmitting structure, and one of the first blade group and the second blade group in the second state is not configured to cooperate to form a light-transmitting hole corresponding to the light-transmitting structure.

11. The electronic device according to claim 10, wherein:
during a process of the drive assembly driving the first blade group to switch from the second state to the first state, the second blade group remains stationary; and
during a process of the drive assembly driving the second blade group to switch from the second state to the first state, the first blade group remains stationary.

12. The electronic device according to claim 10, further comprising a reference hole, wherein:
in response to the first blade group being in the first state to form the first hole, an area of the reference hole blocked by the first blade group is a first area;
in response to the second blade group being in the first state to form the second hole, an area of the reference aperture blocked by the second blade group is a second area; and
the first area and the second area are different.

13. The electronic device according to claim 10, wherein:
the controller controls the drive assembly to drive the first blade group along a first direction to switch from the second state to the first state;
the controller controls the drive assembly to drive the second blade group along a second direction to switch from the second state to the first state; and
the first direction is different from the second direction.

14. The electronic device according to claim 13, further comprising a transmission assembly connected to the drive assembly, wherein:
the controller controls the drive assembly to drive the transmission assembly to drive the first blade group;
the transmission assembly includes a first guide post;
the first blade group includes a first guide rail and a first fixed post, the first guide rail including a first guide segment and a second guide segment;
the first guide post passes through the first guide rail and is arranged between the first guide segment and the second guide segment;
the controller controls the drive assembly to drive the transmission assembly to move along the first direction, the first blade group moves with the first guide post at the first guide segment, and the first blades rotate around the first fixed post to form the first hole; and
the controller controls the drive assembly to drive the transmission assembly to move along the second direction, the first guide post moves at the second guide segment, and the first blade group remains stationary.

15. The electronic device according to claim 14, wherein:
the transmission assembly includes a second guide post;
the second blade group includes a second guide rail and a second fixed post, and the second guide rail includes a third guide segment and a fourth guide segment;
the second guide post passes through the second guide rail and is arranged between the third guide segment and the fourth guide segment;
the controller controls the drive assembly to drive the transmission assembly to move along the first direction, the second guide post moves at the fourth guide segment, and the second blade group remains stationary; and
the controller controls the drive assembly to drive the transmission assembly to move along the second direction, the second blade group moves with the second guide post at the third guide segment, and the second blades rotate around the second fixed post to form the second hole.

16. The electronic device according to claim 8, further comprising:
a reference hole different from the first hole and the second hole;
wherein:
in response to the controller not outputting an electrical signal to control the first blade group and the second blade group, external light passes through the reference hole to be mapped onto the photosensitive surface of the image acquisition element.
